(19) United States
(12) Patent Application Publication
(10) Pub. No.: US 2005/0144311 A1
(43) Pub. Date: Jun. 30, 2005

(54) Communications network for transmitting packets of data via a plurality of sequential routers from a transmitting station to a receiving station with packet header coding for maximizing transmission efficiency

(75) Inventor: Oliver Keren Ban, Austin, TX (US)

Correspondence Address: Mark E. McBurney;International Business Machines Corporation, Intellectual Property Law Department, Internal Zip 4054, 11400 Burnet Road, Austin, TX, 78758, US

(73) Assignee: International Business Machines Corporation, Armonk, NY (US)

(21) Appl. No.: 10/730,954

(22) Filed: Dec. 9, 2003

(51) Int. Cl. G06F 15/16

(52) U.S. Cl. 709/236

(57) ABSTRACT

A system for expediting the transmission of packets in a communication network wherein packets of data are transmitted from a transmitting station to an addressed receiving station via a plurality of routers that determine the path of the transmission. The system comprises means for transmitting packets, each comprising a payload section including the content data being transmitted, a header including the address of the receiving station and a plurality of other headers in combination with means for substituting a code item to represent the plurality of headers other than the address header in the packet. Because of the redundancy in the variety of platforms, operating systems and like protocols that Web document packets are committed to support, the plurality of headers that are to be represented by code may be readily subject to entropic encoding. Most of the combinations of headers required to support the variety of Web platforms, operating systems and related protocols may be represented by a code book listing about 30-36 symbols or items to header set conversions.

### TECHNICAL FIELD

The present invention relates to communication networks, and particularly to systems for maximizing the efficiency of packet transmission via sequential routers.

### BACKGROUND OF RELATED ART

With the globalization of business, industry and trade wherein transactions and activities within these fields have been changing from localized organizations to diverse transactions over the face of the world, the telecommunications and related communications systems linked, the World Wide Web (Web) or Internet have, accordingly, been expanding rapidly. While communications technology development has been advancing to keep pace with expanded demands, communication channel bandwidth remains a relatively costly commodity. Bandwidth is the amount of data that can be transmitted via a given communications channel in a given unit of time (generally one second). Channel and bandwidth shortages still remain the factors that limit the full effectiveness of long distance communications. Because of this rapid expansion of industry and commerce, communication bandwidth needs over the past decade, the communications industry has been rapidly expanding the worldwide infrastructure needed to satisfy these needs.

The technology that has been driving the very rapid development of communications continues to be the Internet or Web (the terms are used interchangeably herein). Via the Web, businesses and consumers have direct access to all matter of databases providing documents, media and computer programs through related distribution of Web documents, e.g. Web pages or electronic mail. Because of the ease with which documents are distributable via the Web, it has become a major source of data. Virtually all databases of public information throughout the world are accessible and able to be searched via the Web.

The ease with which great volumes of data may be searched from a computer attached to the Internet and equipped with a Web browser has led to the development of widespread electronic commerce over the Web. At the present time, it is becoming very rare to find a business organization of any kind that does not transact some aspect of the business via the Web. As consumers and businesses become more familiar and comfortable with Web transactions, they become more and more willing to try the Web for other commerce.

In order for Internet communications to move the great volumes of data to meet user demands, it relies, to a great extent, on the transmission of the data broken into packets and sent from a transmitting station (TX) via a selected sequence of routers to a receiving station (RX). In doing so, the Internet has relied upon and built on data packet transmission technology first developed for the public telecommunication industries. As described in Newton's Telecom Dictionary, 2003, CMP Books, San Francisco, Calif., at page 588, the basic telecommunications packet consists of a section of the basic data content to be transmitted, i.e. the payload, the headers containing control information such as synchronizing bits, the destination address (receiving station), address of transmitting station and packet size. The telephone transmission or, in the case of the Web, Web document data being transmitted is broken into smaller packets designated for the final destination, the receiving station. The packets are routed via a plurality of sequential special purpose computers known as routers. In “circuit switched” transmissions, all of the packets from the same Web document or telecom transmission are moved substantially along the same sequential router path. However, in “packet switched” transmission as described on page 589 of the above-referenced, Newton's Telecom Dictionary, which has become the primary packet transmission vehicle of the Web, the individual packets in a Web document travel along different paths through different routers that only look at the destination address and decide what is currently the best route to the destination address. Once the packets reach their destination, they are reassembled into their original telecom or Web document. The routers make their routing decisions based upon information that is continually being fed to them from other routers with reference to links that are down, congested or slow or even no longer accepting packets.

In the public telecommunications industries for which packet transmission technology was originally developed, the headers in each packet were relatively small, as compared to the payload content in each packet. Thus, header size was not considered to present any problems. This continued into the early periods of packet transmission over the Internet or Web. However, it has been found that the increasing demand for Internet services over a wide variety of platforms and operating systems has resulted in much more complicated and extensive nested header structures that are occupying a larger and larger portion of the data packet. This has a potential slowing and limiting effect on the packet transmission of data, particularly when the routing system itself is subject to transmission bottle necks.

### SUMMARY OF THE PRESENT INVENTION

The present invention provides for minimizing the effects of the larger more complex nested header structures required in present Internet packet transmission systems. Accordingly, the present invention involves a system for expediting the transmission of packets in a communication network wherein packets of data are transmitted from a transmitting station to an addressed receiving station via a plurality of routers that determine the path of the transmission. The system comprises means for transmitting packets, each comprising a payload section including the content data being transmitted, a header including the address of the receiving station and a plurality of other headers in combination with means for substituting a code item to represent the plurality of headers other than the address header in the packet. There is redundancy in the variety of platforms, operating systems and like protocols that Web documents packets are committed to support. Because of this redundancy, the plurality of headers that are to be represented by code may be readily subject to entropic encoding, i.e. lossless compression that is described at page 295 of the above-mentioned Newton's Telecom Dictionary. For example, it has been found that most of the combinations of headers required to support the variety of Web platforms, operating systems and related protocols may be represented by a code book listing about 30-36 symbols or items to represent most possible combinations.

The system further includes the combination of means for determining via the remaining address header which of said routers is the destination router to the receiving display station, means for providing conversion means, e.g. code book to this terminal router for converting the code item back into said plurality of headers represented by the code items, whereby the conversion means converts the code item or symbol back into said original plurality of headers and means for then transmitting the packet with the original plurality of headers from said terminal router to the receiving display station. In accordance with one aspect of the invention, the conversion means is only provided to the terminal router for a packet if such conversion means has not been previously provided to the particular router. When the conversion means, e.g. code book or conversion table, is provided, the code book is stored at the router so that it will not have to be sent again for subsequent conversions of header codes of packets.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a generalized diagrammatic view of a portion of the Internet showing how packets may be routed from transmission (TX) stations to receiving (RX) stations according to the present invention;

FIG. 2 is a block diagram of a generalized display computer system including a processor unit that may perform the functions of the display computers through which the routed packets may be transmitted and received, as well as the functions of server computers;

FIG. 3 is an illustration of a packet being transmitted according to the present invention through the original state of the packet, the packet with code represented headers state during transmission and the final received state after being converted via the code book at the destination router;

FIG. 4 is a flowchart describing how the packet routing system of the present invention is set up to code represent the packet headers to minimize the effect of packet header size on the efficiency of the packet routing transmissions; and

FIG. 5 is a flowchart of an illustrative run of the program set up in FIG. 4.

### DETAILED DESCRIPTION OF THE PREFERRED EMBODIMENT

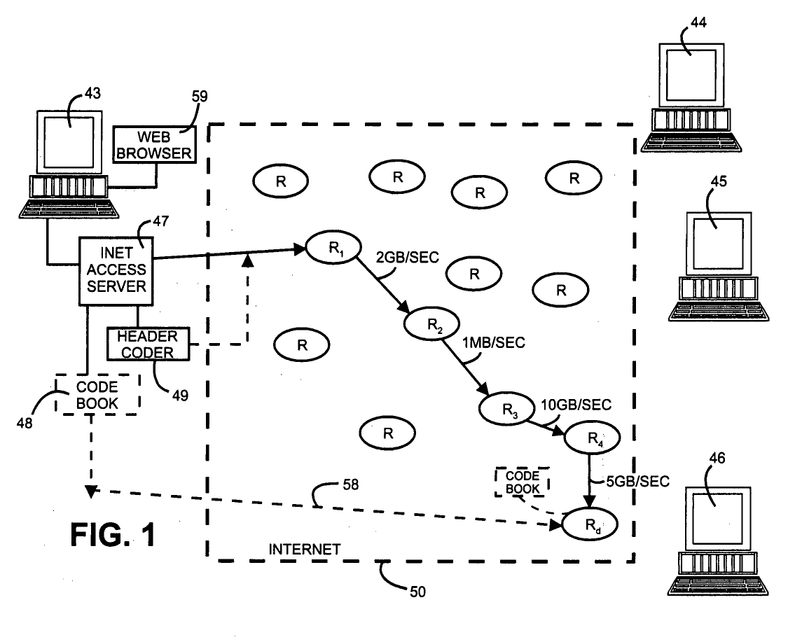

Referring to FIG. 1, there is shown a generalized diagrammatic view of a portion of the Web or Internet. Computer 43 is a transmitting display station on the Web that is indicated as defined by dashed line 50. Any conventional Web browser application program, such as Microsoft's Internet Explorer™, or Lotus Notes™ Personal Web Navigator or Server Web Navigator will be available to support the transmission of the Web document that is broken into packets. Station 43 is transmitting a Web document that the packet switching system has divided into a plurality of data packets. The transmission of one of such packets will be described. Web station computers 44, 45 and 46 are potential receiving stations. Web browser 59 directs the Web document to Web or Internet access server 49 where the packets making up the Web documents are transmitted to the Internet or Web. The header coding program of the present invention may be operational at the server 47. A code is selected by coder program 49 from the code book that may be stored in association with server 47. The packet has all of the header content other than the address header represented by a code item from the code book. The destination of the packet is determined from the address header to be destination router Rd connected to the receiving Web station 46. Since there was no code book 48 at destination router Rd, book 48 is sent directly from server 47 to Rd as indicated by connection 58. In the meantime, the packet with the code item for plurality of headers is routed along the following switched packet router path: from R1 to R2 at a bandwidth of 2 Gb/sec; then from R2 to R3 at a bandwidth of 1 Mb/sec; then from R3 to R4 at a bandwidth of 10 Gb/sec; then from R4 to Rd at a bandwidth of 5 Gb/sec. Because of the code representation of packet headers that reduces the total packet load by 20%, the packet is able to pass through the bottle neck between R2 and R3 and still have an effective bandwidth transmission for the whole path through the router system. Then, as will hereinafter be described in greater detail with respect to the program description, the code item is located in the code book 48, sent to and stored at Rd and the original packet is decoded, restored and then transmitted to the receiving station 46. The routers are conventional routers used in communication networks, such as the Internet routers described in detail in the text Using Networks, Frank Derfler, 1998, published by the QUE Division, Macmillan, Indianapolis, Ind., 42690, at pp. 259-266.

Before going further, it may be helpful to consider the Internet or Web from a more general perspective. For details on Internet nodes, objects and links reference is made to the text, Mastering the Internet, G. H. Cady et al., published by Sybex Inc., Alameda, Calif., 1996. The Internet or Web is a global network of a heterogeneous mix of computer technologies and operating systems. Higher level objects are linked to the lower level objects in the hierarchy through a variety of network server computers.

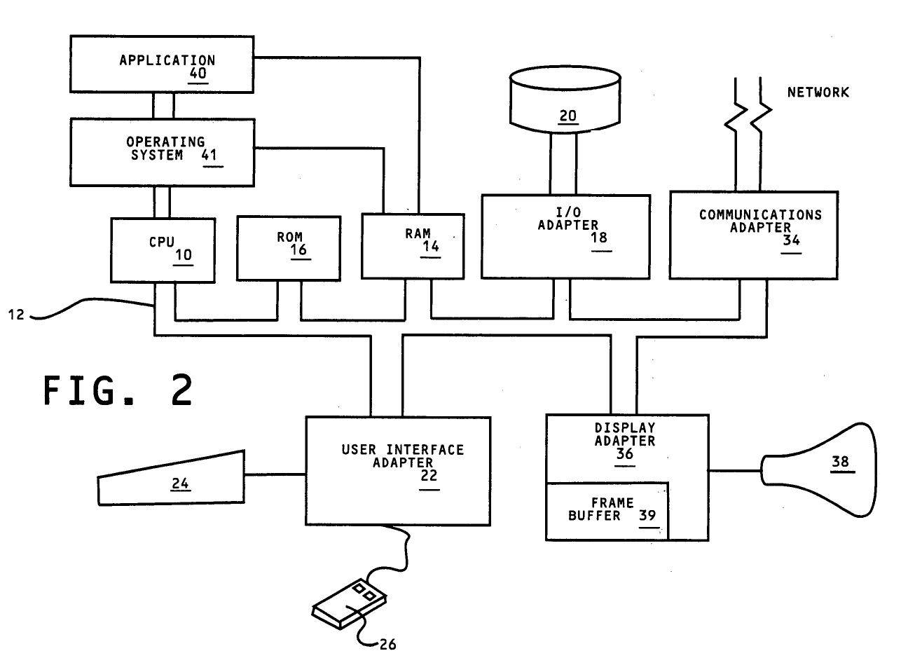

Referring to FIG. 2, a typical data processing system is shown that may function as the computer controlled network receiving and transmitting stations, such as stations 43 to 46 in FIG. 1, as well as for network servers, such as server 47.

A central processing unit (CPU) 10, may be one of the commercial microprocessors in personal computers available from International Business Machines Corporation (IBM) or Dell Corporation; when the system shown is used as a server computer at the Web distribution site to be subsequently described, then a workstation is preferably used, e.g. RISC System/6000™ (RS/6000) series available from IBM. The CPU is interconnected to various other components by system bus 12. An operating system 41 runs on CPU 10, provides control and is used to coordinate the function of the various components of FIG. 1. Operating system 41 may be one of the commercially available operating systems such as the AIX 6000™ operating system available from IBM; Microsoft's Windows XPT™ or Windows2000™, as well as UNIX and other IBM AIX operating systems. Application programs 40 controlled by the system are moved into and out of the main memory Random Access Memory (RAM) 14. These programs may include aspects of the present invention. Other programming aspects of the invention are carried out in Internet server 47. Any conventional Web browser application program 59, such as Microsoft's Internet Explorer™, or Lotus Notes™ Personal Web Navigator or Server Web Navigator, may be available on transmitting receiver 43. A Read Only Memory (ROM) 16 is connected to CPU 10 via bus 12 and includes the Basic Input/Output System (BIOS) that controls the basic computer functions. RAM 14, I/O adapter 18 and communications adapter 34 are also interconnected to system bus 12. I/O adapter 18 communicates with the disk storage device 20. Communications adapter 34 interconnects bus 12 with the outside network enabling the computer system to communicate with other such computers over the Web or Internet. I/O devices are also connected to system bus 12 via user interface adapter 22 and display adapter 36. Keyboard 24 and mouse 26 are all interconnected to bus 12 through user interface adapter 22. It is through such input devices that the user at a receiving or transmitting station may interactively relate to the Web in order to access Web documents and telecommunication packets. Display adapter 36 includes a frame buffer 39 that is a storage device that holds a representation of each pixel on the display screen 38. Images may be stored in frame buffer 39 for display on monitor 38 through various components, such as a digital to analog converter (not shown) and the like. By using the aforementioned I/O devices, a user is capable of inputting information to the system through the keyboard 24 or mouse 26 and receiving output information from the system via display 38.

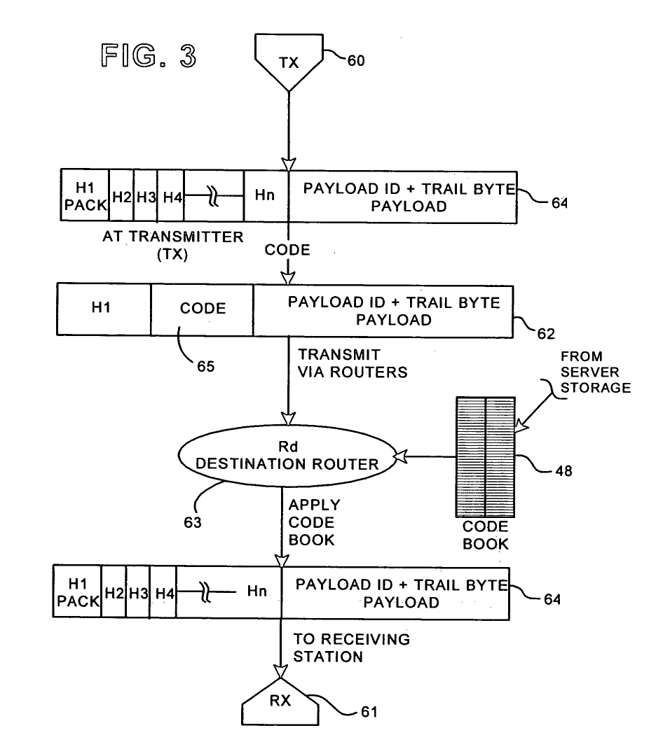

The transmission of a packet will now be described from transmission station (TX) 60 to receiving station (RX) 61 in FIG. 3. The original initial packet 64 has header H1 including the address or destination of the packet. The packet also includes a set (H2 . . . Hn) which is all of the other headers in the packet, as well as the payload that includes a payload ID and trail byte. This packet is subsequently encoded from a code book at TX to the smaller packet 62 in which an appropriate code item 65 or symbol from the code book is substituted for (H2 . . . . Hn). This smaller packet is routed via an appropriate router sequence as described in FIG. 1 until it reaches the destination router (Rd), which is the closest router to RX 61, the address determined from H1. The code book is either already stored at Rd or is sent, as previously described with respect to FIG. 1. Using the code book 48, (H2 . . . Hn) is substituted for code item 65 to thereby restore the packet to its original state 64. The original packet is then sent on the RX 61.

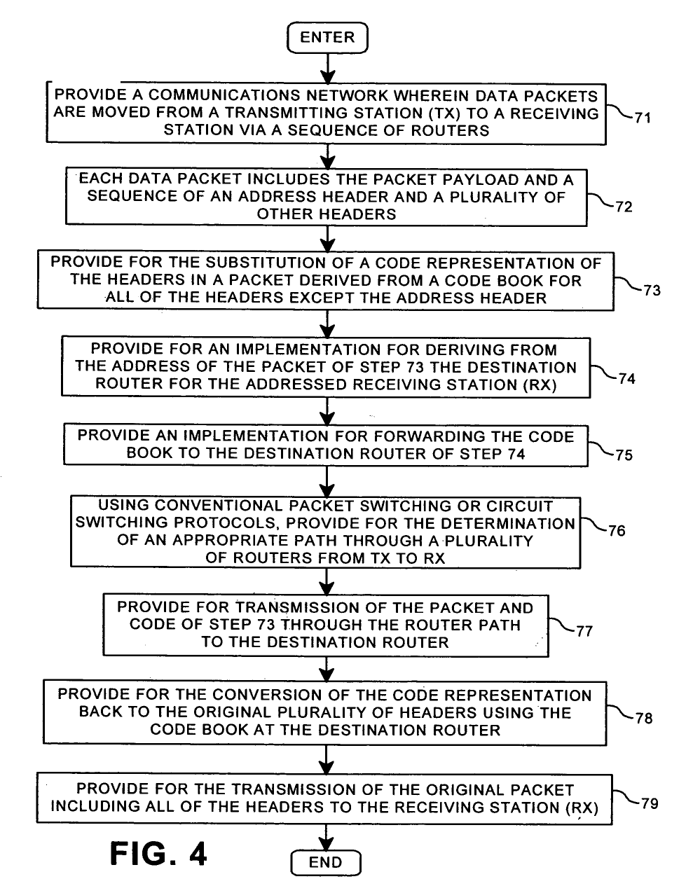

FIG. 4 is a flowchart showing the development of a system according to the present invention for simplifying and expediting routed packet transmissions. A communication network is provided in which data packets are moved from a transmitting station to a receiving station via a sequence of routers, step 71. Each packet includes a packet payload and a sequence of an address header and a plurality of other headers, step 72. Provision is made for the substitution of a code item from a code book as the representation of all the headers except the address header in the packet, step 73. A routine is provided for getting the address of the packet destination RX from the packet of step 73 and determining the router serving the destination, i.e. Rd, step 74. An implementation is provided for forwarding the code book to the destination router if, as previously described, the code book is not already stored at Rd, step 75. As shown in FIG. 1, provision is made for the determination of an appropriate path from TX to RX through a sequence of routers using circuit switching or packet switching protocols, step 76. Provision is made for the transmission of the packet and code of step 73 through the router path to the destination router, step 77. Provision is made for the conversion of the code representation back to the original plurality of headers using the code book at the destination router, step 78. Provision is made for the transmission of the original packet including all of the headers from the destination router to the receiving station RX, step 79.

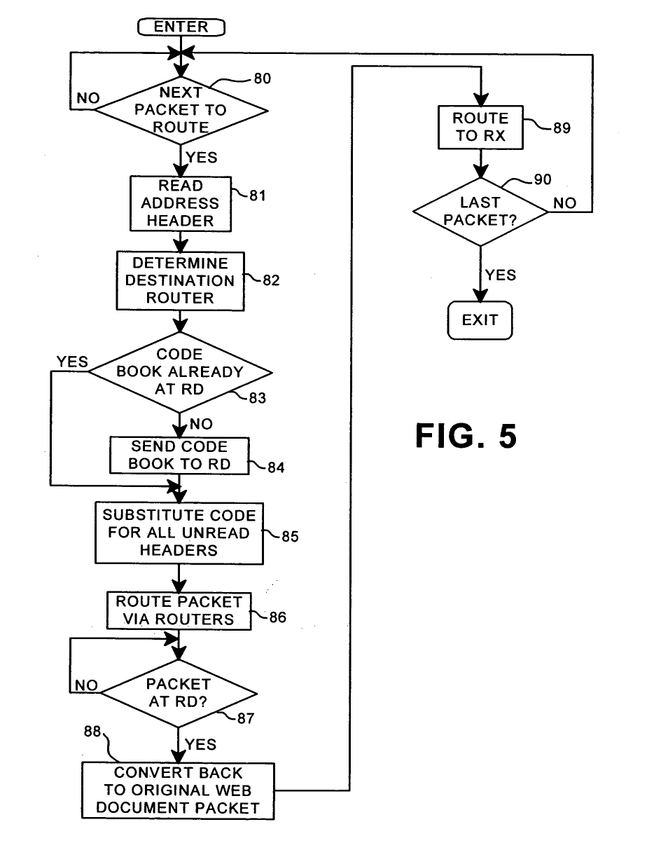

A simplified running of the process set up in FIG. 4 and described in connection with FIGS. 1 and 3 will now be described with respect to the flowchart of FIG. 5. As each packet is transmitted from TX, a determination is first made as to whether there is a next packet to be routed, step 80. If Yes, the address header is read, step 82, to determine the RX address. The destination router is determined from the RX address of step 82. A determination is then made as to whether the code book is already stored at Rd, the destination router, step 83. If No, the code book is sent and stored at the destination router, step 84. Then, or if Yes, the code book has already been stored at Rd, the code item from the code book representative of all the other (H2 . . . Hn) headers is substituted for (H2 . . . Hn) in the packet, step 85. The packet is then routed as described to the destination router, step 86. A determination is made at Rd as to the arrival of this next packet, step 87. When Yes, the packet has arrived, the code item in the packet is converted back to (H2 . . . Hn) using the code book at Rd, step 88. This packet in its original form is routed to RX, step 89. A determination is then made as to whether the routed packet was the last one, step 90. If Yes, the system is exited. If No, the process is branched back to step 80.

Although certain preferred embodiments have been shown and described, it will be understood that many changes and modifications may be made therein without departing from the scope and intent of the appended claims.

1. In a communication network wherein packets of data are transmitted from a transmitting station to an addressed receiving station via a plurality of routers that determine the path of the transmission, a system for expediting the transmission comprising:
means for transmitting packets, each comprising a payload section including the content data being transmitted, a header including the address of the receiving station and a plurality of other headers;
means for substituting a code item to represent said plurality of other headers in one of said packets being transmitted;
means for determining which of said routers is the destination router to the receiving display station;
means for providing conversion means to said terminal router for converting said code item back into said plurality of headers represented by said code items, whereby conversion means convert said code item back into said original plurality of headers; and
means for transmitting said packet with original plurality of headers from said terminal router to said receiving display station.

2. The communication network system of claim 1 wherein said means for providing said conversion means provide said conversion means to only said destination router.

3. The communication network system of claim 1 wherein:
said means for providing said conversion means provide said conversion means to a set of said routers;
and further including:
means at each of said set of routers for determining if the header including the address of the receiving station indicates that the router is the destination router; and
means responsive to said determining means for converting said code item through said conversion means back into said represented plurality of headers upon a determination that said router is the destination router.

4. The communication network system of claim 2 wherein said conversion means includes a conversion table.

5. The communication network system of claim 4 wherein said network is a packet switching network.

6. In a communication network wherein packets of data are transmitted from a transmitting station to an addressed receiving station via a plurality of routers that determine the path of the transmission, a system for expediting the transmission comprising:
means for transmitting packets, each comprising a payload section including the content data being transmitted, a header including the address of the receiving station and a plurality of other headers;
means for substituting a code item to represent said plurality of other headers in one of said packets being transmitted;
means for determining which of said routers is a last router beyond which normal transmission is expedited;
means for providing conversion means to said last router for converting said code item back into said plurality of headers represented by said code items, whereby conversion means convert said code item back into said original plurality of headers; and
means for normally transmitting said packet with original plurality of headers from said last router to said receiving display station.

7. The communication network system of claim 6 wherein said means for providing said conversion means provide said conversion means to only said last router.

8. In a communication network wherein packets of data are transmitted from a transmitting station to an addressed receiving station via a plurality of routers that determine the path of the transmission, a method for expediting the transmission comprising:
transmitting packets, each comprising a payload section including the content data being transmitted, a header including the address of the receiving station and a plurality of other headers;
substituting a code item to represent said plurality of other headers in one of said packets being transmitted;
determining which of said routers is the destination router to the receiving display station;
providing said conversion process to said terminal router for converting said code item back into said plurality of headers represented by said code items, whereby conversion means convert said code item back into said original plurality of headers; and
transmitting said packet with original plurality of headers from said terminal router to said receiving display station.

9. The communication network method of claim 8 wherein said conversion process is provided only to said destination router.

10. The communication network method of claim 8 wherein:
said conversion process is provided to a set of said routers;
and further including:
determining at each of said set of routers if the header including the address of the receiving station indicates that the router is the destination router; and
converting said code item through said conversion process back into said represented plurality of headers upon a determination that said router is the destination router.

11. The communication network method of claim 9 wherein said conversion step uses a conversion table.

12. The communication network method of claim 11 wherein said network is a packet switching network.

13. In a communication network wherein packets of data are transmitted from a transmitting station to an addressed receiving station via a plurality of routers that determine the path of the transmission, said method for expediting the transmission comprising:
transmitting packets, each comprising a payload section including the content data being transmitted, a header including the address of the receiving station and a plurality of other headers;
substituting a code item to represent said plurality of other headers in one of said packets being transmitted;
determining which of said routers is a last router beyond which normal transmission is expedited;
providing a conversion process to said last router for converting said code item back into said plurality of original headers represented by said code items; and
transmitting said packet normally with original plurality of headers from said last router to said receiving display station.

14. The communication network method of claim 13 wherein said means for providing said conversion means provide said conversion means to only said last router.

15. A computer program having code recorded on a computer readable medium for expediting the transmission in a communication network wherein packets of data are transmitted from a transmitting station to an addressed receiving station via a plurality of routers that determine the path of the transmission, said program comprising:
means for transmitting packets, each comprising a payload section including the content data being transmitted, a header including the address of the receiving station and a plurality of other headers;
means for substituting a code item to represent said plurality of other headers in one of said packets being transmitted;
means for determining which of said routers is the destination router to the receiving display station;
means for providing conversion means to said terminal router for converting said code item back into said plurality of headers represented by said code items, whereby conversion means convert said code item back into said original plurality of headers; and
means for transmitting said packet with original plurality of headers from said terminal router to said receiving display station.

16. The computer program of claim 15 wherein said means for providing said conversion means provide said conversion means to only said destination router.

17. The computer program of claim 15 wherein:
said means for providing said conversion means provide said conversion means to a set of said routers;
and further including:
means at each of said set of routers for determining if the header including the address of the receiving station indicates that the router is the destination router; and
means responsive to said determining means for converting said code item through said conversion means back into said represented plurality of headers upon a determination that said router is the destination router.

18. The computer program of claim 16 wherein said conversion means includes a conversion table.

19. The computer program of claim 18 wherein said network is a packet switching network.

20. A computer program having code recorded on a computer readable medium for expediting the transmission in a communication network wherein packets of data are transmitted from a transmitting station to an addressed receiving station via a plurality of routers that determine the path of the transmission, said program comprising:
means for transmitting packets, each comprising a payload section including the content data being transmitted, a header including the address of the receiving station and a plurality of other headers;
means for substituting a code item to represent said plurality of other headers in one of said packets being transmitted;
means for determining which of said routers is a last router beyond which normal transmission is expedited;
means for providing conversion means to said last router for converting said code item back into said plurality of headers represented by said code items, whereby conversion means convert said code item back into said original plurality of headers; and
means for normally transmitting said packet with original plurality of headers from said last router to said receiving display station.

21. The computer program of claim 20 wherein said means for providing said conversion means provide said conversion means to only said last router.
